(19) United States
(12) Patent Application Publication
(10) Pub. No.: US 2004/0080275 A1
(43) Pub. Date: Apr. 29, 2004

(54) Device for automatically switching lighting equipment, in particular for a motor vehicle

(76) Inventors: Patrick Schmitt, Lichtenau (DE); Bruno Hodapp, Achern-Oensbach (DE); Hans Meier, Ottersweier (DE); Henry Blitzke, Buehl (DE); Andreas Schneider, Shanghai (CN); Frank Henkel, Buehlertal (DE)

Correspondence Address: KENYON & KENYON, ONE BROADWAY, NEW YORK, NY, 10004, US

(21) Appl. No.: 10/632,162

(22) Filed: Jul. 30, 2003

(30) Foreign Application Priority Data
Aug. 2, 2002 (DE) 102 35 368.9

(51) Int. Cl. H05B 39/04

(52) U.S. Cl. 315/159; 382/104; 280/735; 362/510

(57) ABSTRACT

A device for automatically switching lighting equipment, in particular for a motor vehicle, having a sensor element that detects at least infrared radiation, and having a filter element, the filter element being designed in such a manner that, in essence, only infrared radiation is detectable by the sensor element.

### BACKGROUND INFORMATION

A number of devices are already known, for example, from German Patent Application No. DE 199 33 642, which provides sensor elements that are supplied with filter elements and detect radiation. These sensor elements emit signals, as a function of which the lighting equipment is switched. Since these devices are intended to switch the lighting equipment as a function of the daylight, such devices use filters that are, in essence, only transparent in the range of visible light, i.e. in the wavelength range between 400 and 730 nm.

### SUMMARY OF THE INVENTION

The device of the present invention has the advantage that the filter element is designed in such a manner that, in essence, only infrared radiation may be detected by the sensor element. Extensive trials have shown that such filtering produces an improved response and, therefore, an improved control function of the lighting equipment.

It should be regarded as a further advantage that the device region provided for incident radiation may have a dark color. Therefore, the device may be mounted in the region of the optical wedge of a motor-vehicle wind shield, without being perceived as an optically disturbing, foreign body.

In a simple development, the sensor is able to emit a signal, which may be supplied to a control device that has an element for switching the lighting equipment as a function of signal S.

It is particularly advantageous for the filter element to be attachable to the window pane (windshield), since this normally represents the direction of incidence of the light. In this manner, the filter elements having focusing characteristics may be combined, and the radiation may be detected in the forward direction. In this manner, a foresighted control characteristic is attained.

It is particularly advantageous for a rain sensor to be provided with a light-conducting element, which is, in essence, only transparent with respect to infrared radiation and is simultaneously used as a filter element for the device according to the present invention. In this manner, a separate filter element may be dispensed with, and the light-conducting element of the rain sensor may be used as a filter element. The light-conducting elements of rain sensors are often only transparent in the infrared range and are opaque with respect to visible light.

In a particularly simple, specific embodiment, this may be attained by providing at least a part of the surface of the light-conducting element with a layer in the incident direction of the radiation, the layer being, in essence, only transparent with respect to infrared radiation. Thus, only a thin layer of the relatively expensive colored pigments is needed to filter out the visible radiation, and this yields a particularly cost-effective, specific embodiment of the present invention.

It is particularly advantageous for the layer to be elastic and/or adhesive, since, in this manner, it may be used, in itself, as a coupling means between the window pane and the device.

In a further, advantageous embodiment, the filter element is integrated into the sensor element. Such sensor elements may be obtained inexpensively as finished components.

### BRIEF DESCRIPTION OF THE DRAWINGS

FIG. 1 shows a schematic cross-sectional view of a device according to the present invention.

FIG. 2 shows a perspective view of a light-conducting element of a rain sensor, the rain sensor belonging to a device according to the present invention and having an integrated filter element.

### DETAILED DESCRIPTION

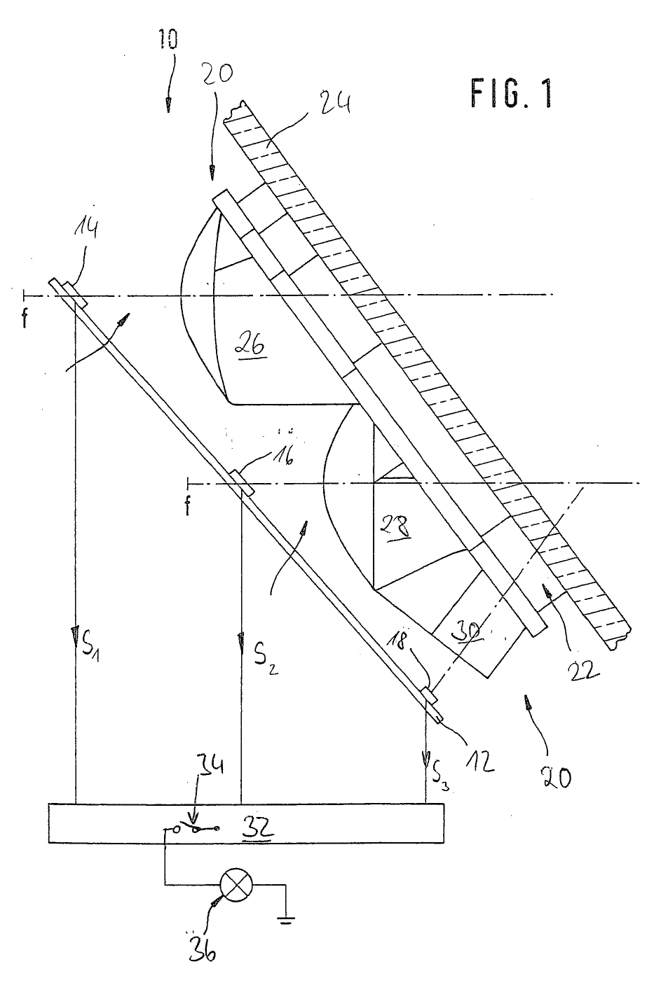

FIG. 1 shows a schematic representation of a cross section of a device according to the present invention.

Sensor device 10 includes a printed circuit board 12, on which sensor elements 16, 14, 18 are situated. Sensor elements 14, 16, 18 take the form of SMD components and are directly attached to printed circuit board 12. A first light-conducting element 20, which is attached to a window pane 24 of a motor vehicle by an elastic, coupling pad 22, is situated in the detecting range of sensor elements 14, 16, 18. To this end, coupling pad 22 is made of silicon and attached to window pane 24 by an adhesive agent. Light-conducting element 20 is typically provided with spacing elements 21, which set the correct spacing between light-conducting element 20 and printed circuit board 12 having sensor elements 14, 16, 18.

Coupling pad 22 is also provided with colored pigments, which are able to absorb visible light, so that essentially no visible light may pass through coupling pad 22. However, the coupling pad is transparent with respect to infrared light between 400 and 730 nm, so that coupling pad 22 is used as a filtering layer. Such materials are known and sufficiently described in the related art.

Light-conducting element 20 has several, in particular three, focusing elements 26, 28, 30, which direct the infrared radiation from various directions to sensor elements 14, 16, 18. In this context, element 30 has no focusing characteristic, so that a total brightness may be ascertained with the aid of it.

The three sensor elements 14, 16, 18 are connected to a control device 32, which is situated on printed circuit board 12, receives signals S1, S2, S3, and has an element 34 for switching lighting equipment 36.

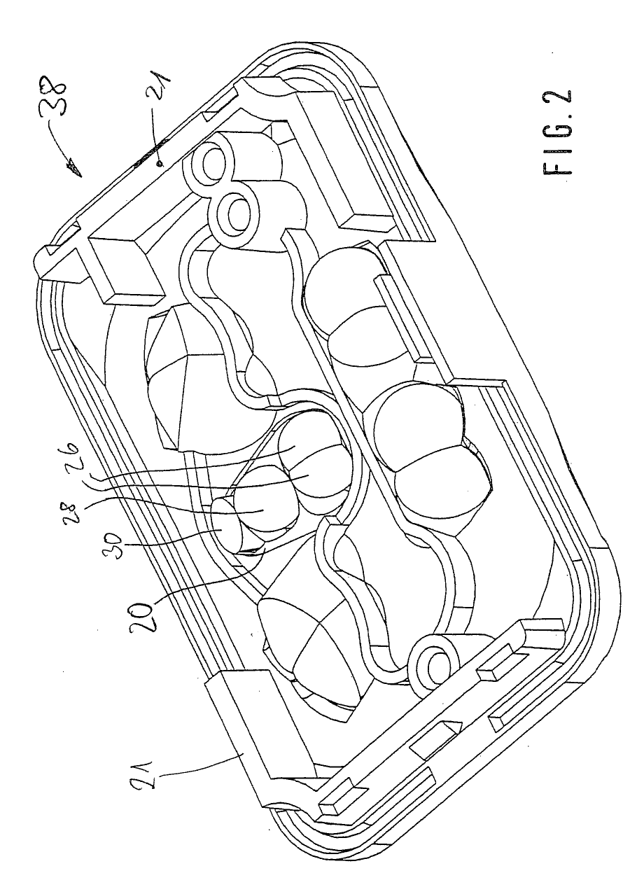

Shown in FIG. 2 is a perspective view of light-conducting element 20 of a device according to the present invention, the light-conducting element being embedded in a further light-conducting element 38 of a rain sensor not shown. Light-conducting element 20 and additional light-conducting element 38 of the rain sensor are formed in one piece and produced from the identical material in an injection molding process. In this case, it is typical for colored pigments to be added to the whole light-conducting element 20, 38 in such a manner, that it essentially allows only infrared radiation to pass through.

Of course, the specific embodiments described may be combined with each other in an arbitrary manner. Thus, a filtering, light-conducting element 20, 38 may be provided with a filtering, coupling pad 22.

In a variation of the present invention, control device 32 and the rain sensor share printed circuit board 12.

What is claimed is:

1. A device for automatically switching lighting equipment comprising:
a sensor element for detecting at least infrared radiation; and
a filter element adapted such that substantially only infrared radiation is detectable by the sensor element.

2. The device according to claim 1, wherein the device is for automatically switching lighting equipment for a motor vehicle.

3. The device according to claim 1, wherein the sensor element emits a signal, and further comprising a control device including an element for switching the lighting equipment as a function of the signal.

4. The device according to claim 2, wherein the filter element is attachable to a glass pane of the motor vehicle.

5. The device according to claim 1, further comprising a rain sensor including a light-conducting element, the light-conducting element being substantially only transparent with respect to infrared radiation and being used as a filter element.

6. The device according to claim 5, further comprising a layer that is substantially only transparent with respect to infrared radiation, the layer being situated on at least a part of a surface of the light-conducting element.

7. The device according to claim 6, wherein the layer is elastic.

8. The device according to claim 6, wherein the layer is adhesive.

9. The device according to claim 1, wherein the filter element is integrated into the sensor element.
